(19) United States
(12) Patent Application Publication
(10) Pub. No.: US 2023/0371488 A1
(43) Pub. Date: Nov. 23, 2023

(54) FISH HAULER

(71) Applicants: William Wade Peterson, Middleton, ID (US); Darlene June Turner, Kodiak, AK (US)

(72) Inventors: William Wade Peterson, Middleton, ID (US); Darlene June Turner, Kodiak, AK (US)

(21) Appl. No.: 18/319,598

(22) Filed: May 18, 2023

Related U.S. Application Data
(60) Provisional application No. 63/364,996, filed on May 19, 2022.

(51) Int. Cl. A01K 97/00

(52) U.S. Cl. CPC A01K 97/00

(57) ABSTRACT

A device for hauling fish, the fishing hauler includes a tubular handle, a plurality of tube spacers, and a plurality of beads, and a closed loop of filament extending through the tubular handle, the plurality of tube spacers, and the plurality of beads, wherein a pattern of one tube spacer of the plurality of tube spacers followed by two beads of the plurality of beads is repeated between the two opposing ends of the tubular handle; and a fish clip connected to the filament between each said two beads, whereby said pattern maintains the fish clips in a spaced apart relation along the filament.

### CROSS-REFERENCE TO RELATED APPLICATION

This application claims the benefit of priority of U.S. provisional application No. 63/364,996, filed 19 May 2022, the contents of which are herein incorporated by reference.

### BACKGROUND OF THE INVENTION

The present invention relates to fishing, and more particularly to apparatus for hauling fish caught during a fishing outing or event.

After a fishing outing or event, for many anglers it is desirable to be able to keep a quantity of fish for either consumption or to take one or more caught fish to a taxidermist for mounting. In many circumstances, desirable fishing spots in a body of water are often located in remote areas that may not be accessible to motor vehicles. Accordingly, the successful angler will have a need to carry their catch from the body of water to their vehicle.

While a device known as a stringer may be suitable for keeping landed fish while the fisherman is engaged in fishing, stringers however are not suited for carriage of the caught fish. Depending on the species, the weight of the caught fish makes carriage by a stringer impractical or impossible except for very short distances. If the angler has caught his or her daily creel limit, the weight of their catch may easily exceed thirty to sixty pounds.

As can be seen, there is a need for a fish hauler to assist the successful angler with hauling their catch.

### SUMMARY OF THE INVENTION

In one aspect of the present invention, a device for hauling fish, the device includes a tubular handle; a plurality of tube spacers; a plurality of beads; a closed loop of filament extending through the tubular handle, the plurality of tube spacers, and the plurality of beads, wherein a pattern of one tube spacer of the plurality of tube spacers followed by two beads of the plurality of beads is repeated between the two opposing ends of the tubular handle; and a fish clip connected to the filament between each said two beads, whereby said pattern maintains the fish clips in a spaced apart relation along the filament.

In another aspect of the present invention, the hauling fish device further includes wherein a barrel swivel interconnects each fish clip to the filament, wherein each fish clip includes a snap operatively associated with the fish clip so that it is movable between an open position and a closed position, further including an end cap on each of the two opposing ends of the tubular handle, wherein the filament comprises rope, cable, or line, wherein the filament, the snaps, and the barrel swivels are rated at over 100 pounds of strength/pound test, and wherein there are five fish clips connected to the filament.

These and other features, aspects and advantages of the present invention will become better understood with reference to the following drawings, description, and claims.

### BRIEF DESCRIPTION OF THE DRAWINGS

FIG. 1 is a front elevation view of an exemplary embodiment of the present invention.

FIG. 2 is a perspective view of an exemplary embodiment of the present invention, invention, shown in use.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, embodiments of the present invention provide a fish hauling apparatus that is configured to permit a successful angler to carry their catch during a fishing outing. The handheld fish hauler is a life saver for hauling a big catch over longer distances. In preferred embodiments, it is configured to haul up to five (5) salmon from an angler's favorite fishing spot back to their car or boat.

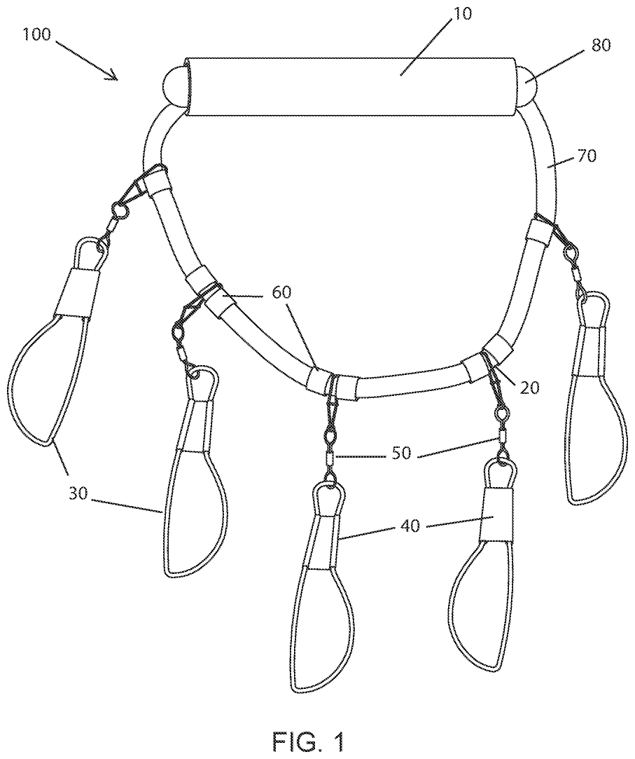

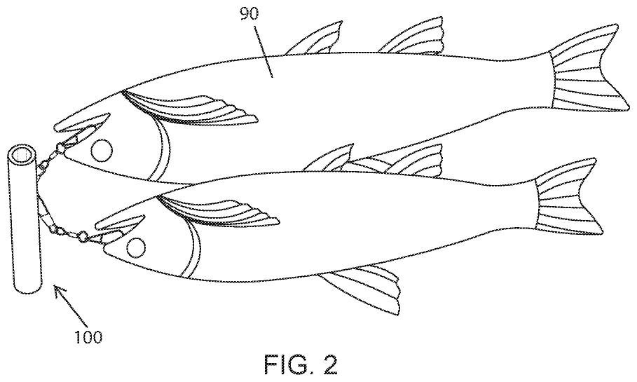

Referring to FIGS. 1 and 2, the present invention may include a fish hauler 100 that saves the angler's hands, arms and back by providing an evenly distributed fish hauler that fits the hand and makes it much easier for hauling fish than a stringer.

The fish hauler 100 may be configured so that it is rated for 100+ lbs. of fish 90 per snap 40. The materials are selected of non-corrosive materials so a quick rinse in fresh water after each use and a little oil at the end of season and it will last.

The fish hauler 100 according to aspects of the invention include a handle 10 that permits the fisherman to hold and carry one or more fish 90. The tubular handle may be made from any suitable material and is preferably formed of a length of PVC piping. The handle 100 may have a length of approximately 6½ inches and a diameter of approximately ¾ inch in diameter. The inventors have found that a section of 480 PSI PVC pipe-JM Eagle Brand USA ATSM D1785, provides a handle of suitable strength.

A length of filament 20, cable, rope, or the like is carried by the handle. The filament 20 is not shown in the drawings as it resides under the tubing 20 and beads 60, which are disclosed in more fuller detail below. The ends of the filament 20 may be joined, such as by a knot or a clamp, to retain the filament 20 in a loop through the handle. By way of non-limiting example, the filament 20 may be formed from a 24-inch length of approximately 0.25-inch braided polypropylene line, rated at 150+ lb. strength. Before the ends of the filament 20 are joined, a plurality of releasable clips 30 is disposed in a spaced apart relation along the length of the filament 20. The plurality of releasable clips 30 may include stainless fish snaps 40 rated at 100+ lb. strength. In certain preferred embodiments, there may be five releasable clips 30. The plurality of releasable clips may be attached to a dual (Duo) Lock Size 5 stainless snap, selected to have 100+ lb. strength, or a strength corresponding to that of the fish snaps 40. The snaps 40 are operatively associated with the clips 30, and the snaps 40/30 are interconnected to the filament 20 via a barrel swivel 50 that is rated to the same strength as the clips 30 and the snap 40.

Tube spacers 70 are threaded on the filament 20 between adjacent clips 30 and each tube spacer 70 ends at a bead 60 so that a sequence of a tube spacer 70, bead 60, clip 30, another bead 60, followed by another tube spaced 70 is repeated along the filament 20. Each tube spacer 70 may, for example, have an approximate ¼″inside diameter and have a length of approximately two inches. The snaps 40 are secured around the filament 20 with a bead spacer 60 that is threaded on the filament so that the snap 40 is juxtaposed by a bead 60 on opposing sides of the snap. The tube spacer 70 and bead 60 sequence threaded along the filament 20 between adjacent clips 30 maintains the clips 30 in a spaced apart relation there along. This allows the fish to remain separated and balanced on the fish hauler. The tubular handle 10 has a diameter approximately three times or greater that a tube spacer 70 so that the handle can be grabbed comfortably for long hauls out of the fishing hole, and so that tube spacers 70 can afford room for clipping fish 90.

The beads 60 allow the suspended clips 30 to rotate freely about the filament 20, while preventing the snaps 40 from gouging or damaging the ends of the tube spacers 70.

Once assembled, the ends of the handle 10 may be sealed with end caps 80 to prevent debris and moisture from entering the handle 10. A spray foam may be injected inside the handle 10 to lock a hauler line knot in handle and prevent material from getting inside the handle 10.

One or more fish 90 may be carried by each of the plurality of clips 30 supported by the fish hauler 100. The fish hauler 100 may be used to evenly distribute the weight of the caught fish 90 on the fish hauler by way of the spaced apart arrangement of the plurality of clips 30. The fish hauler 100 is also to be used to carry a catch in a single hand. Alternatively, the weight of the catch may also be distributed on one or more additional haulers carried in the left and right hands to balance the angler's load while hauling their catch. More than one fish may be attached to the fish clips depending on size of the fish for hauling. For example, ten trout or ten walleye could be attached to the fish clips for hauling.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the present invention.

What is claimed is:

1. A device for hauling fish, the device comprising:
a tubular handle;
a plurality of tube spacers;
a plurality of beads;
a closed loop of filament extending through the tubular handle, the plurality of tube spacers, and the plurality of beads, wherein a pattern of one tube spacer of the plurality of tube spacers followed by two beads of the plurality of beads is repeated between the two opposing ends of the tubular handle; and
a fish clip connected to the filament between each said two beads, whereby said pattern maintains the fish clips in a spaced apart relation along the filament.

2. The device of claim 1, wherein a barrel swivel interconnects each fish clip to the filament.

3. The device of claim 2, wherein each fish clip includes a snap operatively associated with the fish clip so that it is movable between an open position and a closed position.

4. The device of claim 3, further comprising an end cap on each of the two opposing ends of the tubular handle.

5. The device of claim 4, wherein the filament comprises rope, cable, or line.

6. The device of claim 4, wherein the filament, the snaps, and the barrel swivels are rated at over 100 pounds of strength.

7. The device of claim 6, wherein there are five fish clips connected to the filament.
